(19) United States
(12) Patent Application Publication
(10) Pub. No.: US 2014/0350190 A1
(43) Pub. Date: Nov. 27, 2014

(54) SULFUR MODIFIED CHLOROPRENE RUBBER AND METHOD FOR PRODUCING SAME, AND MOLDED BODY

(71) Applicant: DENKI KAGAKU KOGYO KABUSHIKI KAISHA, Tokyo (JP)

(72) Inventors: Naoki Kobayashi, Itoigawa-city (JP); Sachiyo Kishi, Itoigawa-city (JP); Takashi Sunada, Itoigawa-city (JP); Motohiro Ose, Itoigawa-city (JP)

(21) Appl. No.: 14/371,969

(22) PCT Filed: Dec. 7, 2012
(86) PCT No.: PCT/JP2012/081770

§ 371 Date: Jul. 11, 2014

(30) Foreign Application Priority Data
Jan. 13, 2012 (JP) 2012-005606

(51) Int. Cl. C08L 11/00

(52) U.S. Cl. CPC C08L 11/00
USPC 525/328.4

(57) ABSTRACT

Provided are a sulfur-modified chloroprene rubber superior in adhesiveness to cable core and fibrous reinforcement material, a method for producing the same, and a molded body prepared from the same. A sulfur-modified chloroprene rubber is prepared in a polymerization step of mixing 100 parts by mass of 2-chloro-1,3-butadiene and 0.1 to 2.0 parts by mass of sulfur and emulsion-polymerizing the mixture to a monomer conversion rate in the range of 60 to 90% and in a plasticizing step of modifying the terminal of the polymer by adding an aqueous medium dispersion containing tetramethylthiuram disulfide in an amount of 10 to 70 mass % to the reaction solution after polymerization. The ¹H-NMR spectrum of the sulfur-modified chloroprene rubber, as determined in deuterochloroform solvent, has two peak tops at 3.55 to 3.61 ppm and at 3.41 to 3.47 ppm, and the ratio (A/B) of peak area (A) at 3.55 to 3.61 ppm to peak area (B) at 4.2 to 6.5 ppm is 0.05/100 to 0.70/100.

### CROSS-REFERENCE TO RELATED APPLICATIONS

This application is a national stage of International Application No. PCT/JP2012/081770, filed Dec. 7, 2012, which claims the benefit of Japanese Application No. 2012-005606, filed Jan. 13, 2012, in the Japanese Patent Office. All disclosures of the document(s) named above are incorporated herein by reference.

### BACKGROUND OF THE INVENTION

1. Field of the Invention

The present invention relates to a sulfur-modified chloroprene rubber, a method for producing the same and a molded body prepared from the sulfur-modified chloroprene rubber. Specifically, it relates to a sulfur-modified chloroprene rubber for production of fiber material-reinforced rubber products such as transmission belts and conveyor belts and a method for producing the same and a molded body prepared from the same.

2. Description of the Related Art

Chloroprene rubbers are classified grossly into sulfur-modified rubbers and non-sulfur-modified rubbers, and they are used in various fields, for example for production of automobile parts, various industrial parts, and adhesives, based on their respective properties. In particular, sulfur-modification-type chloroprene rubber (sulfur-modified chloroprene rubbers) has been used, based on their favorable dynamic properties, for example as transmission belts and conveyor belts for use in automobile and industrial applications.

Generally, the belt products used in these applications are exposed to repeated deformation-restitution by dynamic stress and a cable core or a fibrous reinforcement material such as short fibers is embedded in the products for assurance of high reinforcement and for improvement of durability. However, because of increase of the temperature of use environment and increased use of them under high load condition, recently, the shear deformation and the shear stress applied between the cable core or fibrous reinforcement material and the belt main body increased in these belt products, causing a problem of separation and removal of the reinforcement material from the belt main body.

To overcome the problem of deterioration in durability of the belt products, there is an urgent need for a technology that can adhesively bond the rubber material constituting the belt main body tightly to the cable core and the fibrous reinforcement material. Examples of the conventional method of improving the adhesiveness of a rubber material to the cable core and the fibrous reinforcement material include, for example, those of coating the surface of the cable core or the fibrous reinforcement material with a material favorably adhesive to the rubber material (see Patent Documents 1 to 3).

Also proposed was a method of covering the adhesive layer formed on the surface of the cable core with a thin layer containing a 1,2-polybutadiene derivative modified with maleic acid or maleic anhydride (see Patent Document 4). Further proposed was a chloroprene rubber composition improved in adhesiveness to fibers that is prepared by adding at least one of a thiazole-based vulcanization accelerator or a sulfenamide-based vulcanization accelerator in an amount of 0.5 to 3 wt parts with respect to 100 wt parts of chloroprene rubber (see Patent Document 5).

### CITATION LIST

### Patent Literatures

[Patent Document 1] JP-A No. 2002-317855
[Patent Document 2] JP-A No. 2007-154382
[Patent Document 3] JP-A No. 2010-024564
[Patent Document 4] JP-A No. 2009-275781
[Patent Document 5] JP-A No. 2000-336211

### SUMMARY OF THE INVENTION

### Technical Problem

However, the conventional methods described above have the following problems. Specifically, the methods described in Patent Documents 1 to 4, which respectively improve the adhesiveness from the side of the cable core and the fibrous reinforcement material, demand an additional step of coating the cable core and the fiber material in advance, which leads to deterioration of productivity and increase of production cost. Alternatively, the method described in Patent Document 5 is an indirect method of increasing adhesiveness using a third component, and the third component may affect various physical properties other than the adhesion physical properties.

As described above, conventional methods of improving the adhesiveness between the reinforcement material and the rubber material in a rubber product do not involve direct modification of the rubber (polymer) structure.

In particular, there is currently no reported method of improving the adhesiveness that was developed by focusing on the structure of the chloroprene rubber.

Thus, major objects of the present invention are to provide a sulfur-modified chloroprene rubber superior in adhesiveness to the cable core and the fibrous reinforcement material, a method for producing the same, and a molded body prepared therefrom.

### Solution to Problem

The sulfur-modified chloroprene rubber according to the present invention is a sulfur-modified chloroprene rubber, prepared by mixing 100 parts by mass of 2-chloro-1,3-butadiene and 0.1 to 2.0 parts by mass of sulfur, emulsion-polymerizing the mixture to a monomer conversion rate of 60 to 90%, modifying the polymer terminal thereof by adding an aqueous medium dispersion containing tetramethylthiuram disulfide in an amount of 10 to 70 mass %, wherein the ¹H-NMR spectrum, as determined in deuterochloroform solvent, has peak tops at 3.55 to 3.61 ppm and at 3.41 to 3.47 ppm; and the ratio (A/B) of peak area (A) at 3.55 to 3.61 ppm to peak area (B) at 4.2 to 6.5 ppm is 0.05/100 to 0.70/100.

In the present invention, as the terminal of the polymer is modified by addition of an aqueous medium dispersion containing tetramethylthiuram disulfide in a particular amount to the reaction solution after polymerization, the adhesiveness of the chloroprene rubber to the cable core and the fibrous reinforcement material is improved.

The sulfur-modified chloroprene rubber may be a copolymer of the sulfur-modified chloroprene rubber above that is prepared by mixing additionally other monomers in an amount in the range of less than 50 parts by mass with respect to 100 parts by mass of 2-chloro-1,3-butadiene and copolymerizing the mixture. In such a case, the addition amount of the other monomers may be 20 parts or less by mass with respect to 100 parts by mass of 2-chloro-1,3-butadiene.

In addition, the extract with ethanol/toluene azeotropic mixture of the sulfur-modified chloroprene rubber, as determined by the method specified in JIS K 6229, may be 3.0 to 9.0 mass %.

Further, the rosin acid content of the sulfur-modified chloroprene rubber, as determined by gas chromatograph, may be 2.0 to 7.0 mass %.

The method for producing a sulfur-modified chloroprene rubber according to the present invention is a method for producing a sulfur-modified chloroprene rubber, comprising a polymerization step of mixing 100 parts by mass of 2-chloro-1,3-butadiene and 0.1 to 2.0 parts by mass of sulfur and emulsion-polymerizing the mixture to a monomer conversion rate of 60 to 90%, and a plasticizing step of modifying the terminal of the polymer by adding an aqueous medium dispersion containing tetramethylthiuram disulfide in an amount of 10 to 70 mass % to the reaction solution after polymerization, wherein the ¹H-NMR spectrum of the sulfur-modified chloroprene rubber, as determined in deuterochloroform solvent, has two peak tops at 3.55 to 3.61 ppm and at 3.41 to 3.47 ppm, and the ratio (A/B) of peak area (A) at 3.55 to 3.61 ppm to peak area (B) at 4.2 to 6.5 ppm is 0.05/100 to 0.70/100.

In the production method, the unreacted monomer may be removed before the plasticizing step or after the plasticizing step.

In the polymerization step, other monomers may be added and copolymerized in an amount in the range of less than 50 parts by mass with respect to 100 parts by mass of 2-chloro-1,3-butadiene.

The molded body according to the present invention, which is a molded body prepared from the sulfur-modified chloroprene rubber described above, is for example a transmission belt or a conveyor belt.

### Advantageous Effects of Invention

As the terminal of the polymer is modified by addition of an aqueous medium dispersion containing tetramethylthiuram disulfide in a particular amount to the reaction solution after polymerization, it is possible according to the present invention to produce a sulfur-modified chloroprene rubber improved significantly in adhesiveness and superior in adhesiveness to the cable core and the fibrous reinforcement material.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawing of which:

FIG. 1 is the ¹H-NMR spectrum of the sulfur-modified chloroprene rubber of Example 1 in the present invention.

### DETAILED DESCRIPTION OF THE EMBODIMENTS

Hereinafter, favorable embodiments of the present invention will be described in detail. It should be understood that the present invention is not limited to the embodiments described below.

### First Embodiment

### <Sulfur-Modified Chloroprene Rubber>

First, a sulfur-modified chloroprene rubber in the first embodiment of the present invention will be described. The sulfur-modified chloroprene rubber in the present embodiment is a rubber prepared by modifying, with tetramethylthiuram disulfide, the terminals of a polymer obtained by emulsion polymerization only of 2-chloro-1,3-butadiene (hereinafter, referred to as chloroprene) or emulsion polymerization of chloroprene and other monomers in the presence of sulfur.

Specifically, the sulfur-modified chloroprene rubber in the present embodiment is obtained in a polymerization step of mixing 100 parts by mass of chloroprene, 0.1 to 2.0 parts by mass of sulfur, and as needed, monomers other than chloroprene in an amount in the range of less than 50 parts by mass and emulsion-polymerizing the mixture to a monomer conversion rate in the range of 60 to 90%, and a plasticizing step of modifying the terminal of the polymer by adding an aqueous medium dispersion containing 10 to 70 mass % of tetramethylthiuram disulfide to the reaction solution after polymerization.

### [Monomer]

Examples of the other monomers copolymerizable with chloroprene include 2,3-dichloro-1,3-butadiene, 1-chloro-1,3-butadiene, styrene, acrylonitrile, methacrylonitrile, isoprene, butadiene, methacrylic acid and the esters thereof, and the like. These monomers may be used alone or in combination of two or more.

However when chloroprene is copolymerized with other monomers, the other monomers are added in an amount that does not impair the favorable properties of the sulfur-modified chloroprene rubber obtained. Specifically, the total amount of the other monomers added is preferably less than 50 parts by mass and more preferably 20 parts or less by mass with respect to 100 parts by mass of chloroprene. It is possible in this way to improve the post-vulcanization adhesive force of the sulfur-modified chloroprene rubber obtained, while suppressing dynamic heat generation and preserving the durability life thereof.

### [Sulfur]

The amount of sulfur added during emulsion polymerization is 0.1 to 2.0 parts by mass with respect to 100 parts by mass of chloroprene. When the amount of sulfur blended is less than 0.1 parts by mass with respect to 100 parts by mass of chloroprene, it is not possible to obtain favorable mechanical and dynamic properties characteristic to the sulfur-modified chloroprene rubber, the plasticization rate in the plasticizing step described below declines significantly, leading to deterioration of productivity, and the chloroprene rubber becomes unprocessable because of scorching. Alternatively when the sulfur blending amount is more than 2.0 parts by mass, the Mooney viscosity of the blend drops significantly during processing, leading to deterioration of processability.

### [Emulsifier]

The emulsifier used in the emulsion polymerization is preferably a rosin acid. The “rosin acids,” as used herein, include rosin acids and the salts thereof, disproportionated rosin acids and the salts thereof and also the compounds and derivatives thereof. The emulsifier for use may be a mixture of a rosin acid with another emulsifier or a fatty acid commonly used.

The other emulsifiers used in combination with the rosin acid include metal salts of aromatic sulfonic acid formalin condensates, sodium dodecylbenzenesulfonate, potassium dodecylbenzenesulfonate, sodium alkyldiphenylethersulfonates, potassium alkyldiphenylethersulfonates, sodium polyoxyethylene alkylethersulfonates, sodium polyoxypropylene alkylethersulfonates, potassium polyoxyethylenealkylethersulfonates, potassium polyoxypropylenealkylethersulfonates, and the like.

The fatty acids used in combination with the rosin acid include saturated and unsaturated fatty acids having 6 to 22 carbon atoms and the alkali-metal salts thereof. Typical examples thereof include natural fatty acids such as palmitic acid, stearic acid, oleic acid, linolic acid, linolenic acid, y-linolenic acid, arachidonic acid, EPA (eicosapentaenoic acid), and DHA (docosahexaenoic acid), and the like. Among the fatty acids above, stearic acid and oleic acid are particularly preferable from the practical point of view.

Further, the emulsifier particularly favorable in the preparative method for the sulfur-modified chloroprene rubber in the present embodiment is an aqueous alkali soap solution containing an alkali-metal salt of disproportionated rosin acid and a saturated or unsaturated fatty acid having 6 to 22 carbon atoms. Examples of the constituent components for the disproportionated rosin acid blended in the mixture include sesquiterpenes, 8,5-isopimaric acid, dihydropimaric acid, seco-dehydroabietic acid, dihydroabietic acid, deisopropyldehydroabietic acid, demethyl dehydroabietic acid, and the like.

### [Polymerization Initiator and Inhibitor]

Examples of the polymerization initiators for use include, but are not particularly limited to, those commonly used in radical polymerization such as potassium persulfate, benzoyl peroxide, ammonium persulfate, and hydrogen peroxide. Examples of the polymerization inhibitors for use include, but are not particularly limited to, thiodiphenylamine, 4-t-butylcatechol, 2,2′-methylene-bis-4-methyl-6-t-butylphenol, and the like.

### [Polymerization Condition]

The aqueous emulsion preferably has a pH of 10.5 to 13.0 when the emulsion polymerization is initiated. The “aqueous emulsion,” as used herein, means a liquid mixture of chloroprene, other monomers, emulsifiers, sulfur, and others before polymerization and also during polymerization.

It also includes a liquid mixture wherein the composition varies by delayed or divided addition of monomers, sulfur, and others. It is possible by adjusting the pH of the aqueous emulsion in the range above when the emulsion polymerization is initiated to prepare a sulfur-modified chloroprene rubber superior in various properties reliably.

Alternatively when the pH of the aqueous emulsion is lower than 10.5, use of a rosin acid as the emulsifier may lead to precipitation of the polymer during polymerization, thus prohibiting reliable regulation of polymerization. Yet alternatively when the pH of the aqueous emulsion is higher than 13.0, it may not be possible to obtain desired adhesiveness. The pH of the aqueous emulsion can be controlled, as needed, by adjustment of the addition amount of an alkali component added during polymerization such as sodium hydroxide or potassium hydroxide.

The polymerization temperature during emulsion polymerization is preferably, but not particularly limited to, 0 to 55° C. and more preferably 30 to 55° C., from the viewpoints of polymerization control and productivity. Further in the preparative method for the sulfur-modified chloroprene rubber in the present embodiment, the emulsion polymerization is continued to a conversion rate in the range of 60 to 90%, when the polymerization is terminated by addition of a polymerization inhibitor. A conversion rate of less than 60% is unpractical from the point of productivity, while a conversion rate of more than 90% leads to deterioration of processability of the resulting sulfur-modified chloroprene rubber by development of branched structure and gelling.

### [Plasticizing Step]

In the plasticizing step, the polymer obtained is depolymerized with tetramethylthiuram disulfide for removal of the terminal chain, shortening the polymer chain to a degree suitable for molding processing. It is possible in this way to reduce the Mooney viscosity of the obtained sulfur-modified chloroprene rubber into a suitable range.

Tetramethylthiuram disulfide is then added in the state of aqueous medium dispersion to the reaction solution (latex) containing the sulfur-modified chloroprene rubber. The “aqueous medium dispersion,” as used herein, is a dispersion of a plasticizer tetramethylthiuram disulfide in an aqueous medium containing a surfactant in pure water, which includes a flowable preparation additionally containing a thickener.

The surfactant added to the aqueous medium dispersion may be an anionic surfactant, a nonionic surfactant, or an amphoteric surfactant, but an anionic surfactant is preferable from the viewpoint of stability. Typical examples thereof for use include polyoxyalkylene styrylphenylether phosphate esters, polyoxyethylene alkylphenylether sulfate ester salts, polyoxyethylene alkylphenylether phosphate ester salts, and the like.

The concentration of the surfactant in the aqueous medium dispersion is preferably adjusted to 2 to 10 mass %. When the surfactant concentration is less than 2 mass %, dispersion may become insufficient, leading to sedimentation of the plasticizer and making it difficult to control plasticization. Alternatively when the surfactant concentration is more than 10 mass %, it may not be possible to obtain desired adhesiveness.

The thickener for use may be a xanthan gum, a polymeric carboxymethylcellulose, or the like. When a thickener is added to the aqueous medium dispersion, the thickener concentration in the aqueous medium dispersion is preferably adjusted to 0.1 to 0.5 mass % from the viewpoints of plasticization-regulating efficiency of the dispersion and handling efficiency.

The concentration of tetramethylthiuram disulfide in the aqueous medium dispersion is in the range of 10 to 70 mass %. When the tetramethylthiuram disulfide concentration is less than 10 mass %, it is needed to add a large amount of aqueous medium dispersion to the reaction solution after polymerization, which is unpractical. Alternatively when the tetramethylthiuram disulfide concentration is more than 70 mass %, the aqueous medium dispersion becomes highly viscous, making it difficult to add the dispersion to the reaction solution after polymerization.

Further in the preparative method for the sulfur-modified chloroprene rubber in the present embodiment, tetramethylthiuram sulfide and a tetraalkylthiuram disulfide represented by the following Chemical Formula 1 and/or a dialkyl dithiocarbamate salt represented by the following Chemical Formula 2 may be used in combination as the plasticizer. R₁ to R₄ in the following Chemical Formula 1 each represent an alkyl group having 2 to 7 carbon atoms and may be the same as or different from each other. Alternatively, R₅ and R₆ in the following Chemical Formula 2 each represent an alkyl group having 1 to 7 carbon atoms, and may be the same as or different from each other.

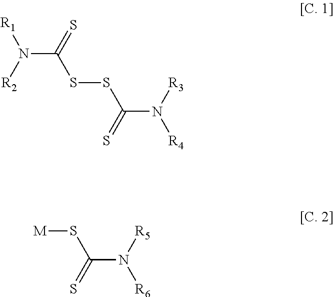

The tetraalkylthiuram disulfides represented by Chemical Formula 1 include tetraethylthiuram disulfide, isopropylthiuram disulfide, tetra-n-propylthiuram disulfide, tetra-n-butylthiuram disulfide, tetra-n-hexylthiuram disulfide, and the like. Alternatively, the dialkyl dithiocarbamate salts represented by Chemical Formula 2 include sodium dimethyl dithiocarbamate, sodium diethyl dithiocarbamate, sodium dibutyl dithiocarbamate, and the like.

It is possible by using tetramethylthiuram sulfide in combination with a tetraalkylthiuram disulfide represented by Chemical Formula 1 and/or a dialkyl dithiocarbamate salt represented by Chemical Formula 2 to improve the plasticization-regulating efficiency and shorten the plasticization period.

The addition amounts of the tetraalkylthiuram disulfide represented by Chemical Formula 1 and the dialkyl dithiocarbamate salt represented by Chemical Formula 2 can be modified properly according to the properties of the sulfur-modified chloroprene rubber obtained, specifically according to the ratio (A/B) of the peak area at 3.55 to 3.61 ppm (A) to that at 4.2 to 6.5 ppm (B) in ¹H-NMR spectrum, as determined in deuterochloroform solvent, and the extract with ethanol/toluene azeotropic mixture (hereinafter, referred to as ETA), as determined by the method specified in JIS K 6229. However when the addition amount of these compounds is too large, specifically when the addition amount is more than 5.0 parts by mass with respect to 100 parts by mass of chloroprene, the chloroprene rubber becomes less adhesive, leading to insufficient adhesive to the cable core and the fibrous reinforcement material.

The plasticizing step using such plasticizers is carried out, for example, at a temperature of 20 to 70° C. until the sulfur-modified chloroprene rubber obtained has a particular Mooney viscosity. The Mooney viscosity (ML1+4, 100° C.) of the sulfur-modified chloroprene rubber in the present embodiment is preferably in the range of 20 to 120, more preferably in the range of 25 to 90, and still more preferably in the range of 30 to 60, from the viewpoint of practical processability.

The Mooney viscosity, as defined herein, is a value determined according to JIS K-6300; the term “ML1+4” indicates that the type-L roller used in Mooney viscosity measurement is preheated for 1 minute and rotated for 4 minutes; and the term “100° C.” indicates that the test temperature is 100° C. These plasticizers may be added, depending on the addition amount, in combination before or after the unreacted monomer-removing step described below.

Further in the plasticizing step, the aqueous medium dispersion described above and the plasticizer emulsion may be used in combination. The plasticizer emulsion used together with the aqueous medium dispersion is, for example, a mixture prepared by adding plasticizers (tetramethylthiuram disulfide, a tetraalkylthiuram disulfide represented by Chemical Formula 1 and/or a dialkyl dithiocarbamate salt represented by Chemical Formula 2) to an aqueous emulsion containing a small amount of a known emulsifier such as an alkali-metal salt of a saturated fatty acid or unsaturated fatty acid having 6 to 22 carbon atoms and/or an alkali-metal salt of β-naphthalenesulfonic acid formalin condensate and mixing under agitation the resulting emulsion using for example an agitating blade or a stirrer.

It is possible by using the plasticizer emulsion and the aqueous medium dispersion in combination to improve the plasticization-regulating efficiency and shorten the plasticization period significantly. The aqueous medium dispersion and the plasticizer emulsion may be added at any timing before or after removal of the unreacted monomer. Alternatively, they may be added in portions before and after removal of the unreacted monomer.

### [Chain-Transfer Agent]

In the plasticizing step, a known chain-transfer agent may be added together with the plasticizer described above. Examples of the known chain-transfer agents include xanthate salts such as potassium ethylxanthate, sodium 2,2-(2,4-dioxopentamethylene)-n-butyl-xanthate, and the like.

### [Stabilizer]

For prevention of the change in Mooney viscosity during storage, a small amount of stabilizer may be added to the sulfur-modified chloroprene rubber obtained in the plasticizing step, to give a sulfur-modified chloroprene rubber composition. Typical examples of the stabilizers include, phenyl-α-naphthylamine, octylated diphenylamines, 2,6-di-tertiary-butyl-4-phenylphenol, 2,2′-methylene-bis(4-methyl-6-tertiary-butylphenol), 4,4′-thiobis-(6-tertiary-butyl-3-methylphenol), and the like. Among these stabilizers, 4,4′-thiobis-(6-tertiary-butyl-3-methylphenol is particularly favorable.

### [Unreacted Monomer-Removing Step]

In preparation of the sulfur-modified chloroprene rubber in the present embodiment, unreacted monomers contained in the reaction solution may be removed, as needed, after emulsion polymerization. The method of removing unreacted monomers after emulsion polymerization is not particularly limited and may be a common method such as distillation under reduced pressure. The removal of unreacted monomers may be carried out before the plasticizing step or after the plasticizing step.

### [NMR Spectrum]

The sulfur-modified chloroprene rubber in the present embodiment prepared by the method described above has peak tops at 3.55 to 3.61 ppm and at 3.41 to 3.47 ppm in the ¹H-NMR spectrum, as determined in deuterochloroform solvent, and the ratio (A/B) of peak area (A) at 3.55 to 3.61 ppm to peak area (B) at 4.2 to 6.5 ppm is 0.05/100 to 0.70/100. When the ratio (NB) is in the range above, the adhesiveness between the sulfur-modified chloroprene rubber and the fibrous reinforcement material can be improved significantly.

The peaks at 3.41 to 3.47 ppm and at 3.55 to 3.61 ppm are derived respectively from the methyl groups in the —N(CH₃)₂ at the terminal of the dimethylthiuram derivative formed when tetramethylthiuram disulfide reacts with the terminal of the chloroprene chain. Two peaks are observed at different chemical shifts, because there are generated geometric isomers by restriction of revolution of CS—N(CH₃)₂ around the C—N bond.

In other words, the presence of two peak tops at 3.41 to 3.47 ppm and at 3.55 to 3.61 ppm indicates that, in the sulfur-modified chloroprene rubber, dimethylthiuram sulfide derived from tetramethylthiuram disulfide is bound to the terminal of the chloroprene chain. On the other hand, the peaks at 4.2 to 6.5 ppm derived mainly from the —CH— groups in the chloroprene main structure, such as trans-1,4-bonds in the chloroprene rubber.

Thus, the ratio (NB) of the peak area (A) at 3.55 to 3.61 ppm to peak area (B) at 4.2 to 6.5 ppm is the ratio (relative value) of the amount of dimethylthiuram sulfide (derived from tetramethylthiuram disulfide) bound to the terminal of the sulfur-modified chloroprene rubber with respect to the total amount of the polymer. It is thus possible to improve the adhesiveness to the cable core and the fibrous reinforcement material by adjusting the ratio (NB) of peak area (A) at 3.55 to 3.61 ppm to peak area (B) at 4.2 to 6.5 ppm of the sulfur-modified chloroprene rubber in the range of 0.05/100 to 0.70/100.

When the ratio (A/B) of the peak area (A) at 3.55 to 3.61 ppm to peak area (B) at 4.2 to 6.5 ppm of the sulfur-modified chloroprene rubber is less than 0.05/100, it is not possible to obtain sufficient adhesiveness. Alternatively when the ratio (A/B) is more than 0.70/100, the sulfur-modified chloroprene rubber obtained shows significantly lower storage stability and higher tackiness, leading to deterioration of processability.

The ¹H-NMR spectrum of the chloroprene rubber can be obtained in the following manner: First, the sulfur-modified chloroprene rubber obtained is purified with benzene and methanol and freeze-dried once again, to give a test sample. The sample is then dissolved in deuterochloroform before ¹H-NMR measurement. The measurement data obtained are calibrated, as compared to the standard peak (7.24 ppm) of chloroform contained in the solvent deuterochloroform.

### [ETA Extract]

Alternatively, the sulfur-modified chloroprene rubber in the present embodiment preferably has an ETA extract, as determined by the method specified in JIS K 6229, of 3.0 to 9.0 mass %. When the ETA extract is in the range above, it is possible to preserve the storage stability of the sulfur-modified chloroprene rubber, while suppressing deterioration in scorching time, and to improve the balance of adhesion properties.

The ETA extract (mass %) can be determined by extracting a pulverized sulfur-modified chloroprene rubber with ETA in a round-bottomed flask equipped with a condenser, determining the mass of the sulfur-modified chloroprene rubber before and after the ETA extraction, and calculating it from the ratio thereof. Specifically, the mass (C) of the sulfur-modified chloroprene rubber before ETA extraction and the mass (D) of the solid matter obtained by drying the ETA extraction solution are determined, and the ETA extract is calculated by (D/C)×100.

The components extracted with ETA include rosin acids, fatty acids, free sulfur or free plasticizers, and the like. The ETA extract can be adjusted properly by modifying the addition amount of the compounds added during emulsion polymerization, the polymerization rate of the sulfur-modified chloroprene rubber, and also the plasticization temperature and period.

### [Rosin Acid Content]

The sulfur-modified chloroprene rubber in the present embodiment preferably has a rosin acid content, as determined by gas chromatography, of 2.0 to 7.0 mass %. The “rosin acid content,” as used herein, indicates the amount of rosin acids remaining in the sulfur-modified chloroprene rubber. It can be determined by extracting a pulverized sulfur-modified chloroprene rubber with ETA in a round-bottomed flask equipped with a condenser, analyzing the ETA-extract obtained by gas chromatography, and thus determining the peak area of the rosin components.

When the amount of rosin acids remaining in the sulfur-modified chloroprene rubber is adjusted in the range above, it is possible to preserve the storage stability, while suppressing deterioration of heat stability, and to improve the balance of adhesive properties to the fibrous reinforcement material. The amount of rosin acids contained in the sulfur-modified chloroprene rubber can be adjusted properly, for example, by modifying the amount of the rosin acids added as emulsifiers and also by modifying the polymerization rate.

As the sulfur-modified chloroprene rubber in the present embodiment has a polymer terminal group modified by addition of an aqueous medium dispersion containing tetramethylthiuram disulfide in a particular amount to the reaction solution after polymerization, it is significantly superior in adhesiveness to the cable core and the fibrous reinforcement material.

### Second Embodiment

Hereinafter, the molded body in the second embodiment of the present invention will be described. The molded body in the present embodiment is a composite molded body of the sulfur-modified chloroprene rubber of the first embodiment described above containing a cable core or a fibrous reinforcement material embedded therein. As the molded body in the present embodiment is made of the sulfur-modified chloroprene rubber of the first embodiment that is superior in adhesiveness, it is also superior in adhesiveness of the rubber material to the cable core and the fibrous reinforcement material. Thus, it is suited for preparation of reinforcement material-containing rubber products in automobile application and general industry application such as transmission belts and conveyor belts.

The adhesive force of a rubber material with a cable core or a fibrous reinforcement material can be determined according to the H test of ASTM D 2138-72. In the “H test,” an H-shaped test sample containing fiber codes embedded in a vulcanized rubber is prepared. The test sample is held between two fabrics, one of the fabric rubber regions is pressed in the region where there is no fiber code, and the fiber code is pulled out of the test sample. The force needed for removal of the fiber code is used as the adhesive force between the fiber code and the rubber material.

### EXAMPLES

Hereinafter, the advantageous effects of the present invention will be described specifically with reference to Examples and Comparative Examples of the present invention. However, it should be understood that the present invention is not limited to these Examples. In the Examples below, the adhesiveness of each of the sulfur-modified chloroprene rubbers of Examples and Comparative Examples prepared by the method below to the fiber code was determined.

### Example 1

### <Preparation of Sulfur-Modified Chloroprene Rubber>

(a) First, chloroprene (2-chloro-1,3-butadiene): 100 parts by mass, 2,3-dichloro-1,3-butadiene: 3.0 parts by mass, sulfur: 0.50 parts by mass, pure water: 120 parts by mass, potassium salt of a disproportionated rosin acid (manufactured by Harima Chemicals, Inc.): 3.80 parts by mass, sodium hydroxide 0.59 parts by mass, and sodium salt of a 13-formalin naphthalenesulfonate condensate (trade name: DEMOL N, manufactured by Kao Corporation): 0.5 parts by mass were placed in a polymerization tank having a capacity of 30 liters, to give an aqueous emulsion. The pH of the aqueous emulsion was 12.8 when the polymerization started.

Potassium persulfate: 0.1 parts by mass was added as polymerization initiator to the aqueous emulsion and the mixture was emulsion-polymerized at a polymerization temperature of 40° C. under nitrogen stream. A polymerization inhibitor diethyl hydroxyamine was added to the mixture for termination of polymerization, when the conversion rate reached 75%.

(b) Then, the latex obtained in the step (a) described above was distilled under reduced pressure for removal of the unreacted monomer, to give a latex after polymerization and before plasticization (hereinafter, this post-polymerization latex will be referred to as “the latex”).

(c) Subsequently, an aqueous medium dispersion: 4.0 parts by mass containing tetramethylthiuram disulfide: 40 mass % and a polyoxyethylene alkylphenylether sulfate ester salt: 8.0 mass % was added to the latex, and the mixture was kept under agitation at a temperature of 50° C. for 1 hour, to plasticize the polymer.

(d) After the plasticizing step, the latex was cooled and the polymer was isolated by the common freeze coagulation method, to give a sulfur-modified chloroprene rubber of Example 1.

### <Measurement of Nuclear Magnetic Resonance (¹H-NMR) Spectrum>

The sulfur-modified chloroprene rubber of Example 1 prepared by the method described above was purified with benzene and methanol, freeze-dried, and dissolved in 5% deuterochloroform solution. The solution thus obtained was subjected to ¹H-NMR spectral analysis in JNM-ECX-400 (400 MHz, FT) manufactured by JEOL Ltd.

The analytical condition for ¹H-NMR spectrum is as follows:
Measurement mode: non-decoupling
Flip angle: 45°
Waiting time: 7.0 seconds
Sample rotation frequency: 0 to 12 Hz
Window treatment: exponential function
Integration number: 512.

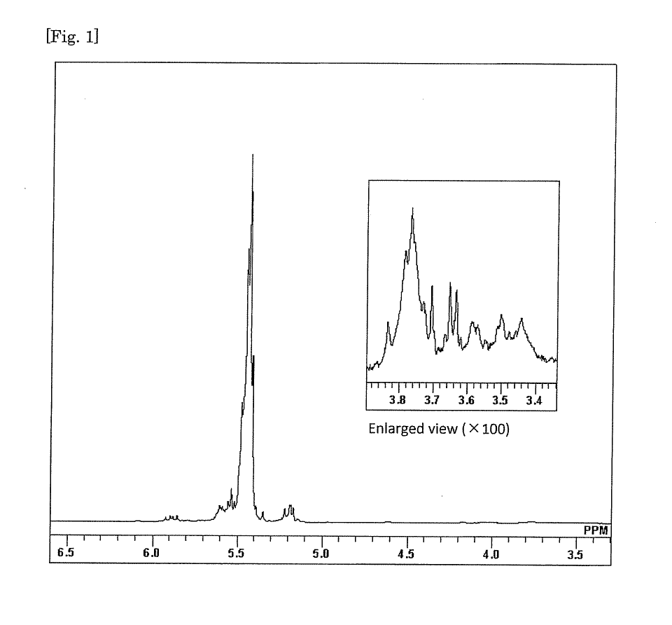

FIG. 1 shows the ¹H-NMR spectrum of the sulfur-modified chloroprene rubber of Example 1. In the ¹H-NMR spectrum obtained (see FIG. 1), there were two peak tops observed at positions of 3.55 to 3.61 ppm and 3.41 to 3.47 ppm, as compared to the standard peak of chloroform contained in deuterochloroform (7.24 ppm), and the area of the peak (A) at 3.55 to 3.61 ppm was determined. As a result, the relative area (A) was 0.35 with respect to 100 of the area (B) of the peak at 4.2 to 6.5 ppm (area ratio (NB): 0.35/100).

### <Measurement of ETA Extract>

The sulfur-modified chloroprene rubber of Example 1 in an amount of 6 g was cut into pieces of 2 mm square, and a piece thereof was extracted with ETA in a round-bottomed flask equipped with a condenser. The extract obtained was dried and the mass thereof was determined and the mass ratio thereof to the sulfur-modified chloroprene rubber was calculated. As a result, the ETA extract was 7.2 mass %.

### <Determination of ETA Extract and Rosin Acid Content>

The sulfur-modified chloroprene rubber of Example 1 in an amount of 6 g was cut into pieces of 2 mm square, and a piece thereof was extracted with ETA in a round-bottomed flask equipped with a condenser. The ETA extract was analyzed by gas chromatography and the rosin acid content was determined from the peak area of rosin components. As a result, the sulfur-modified chloroprene rubber of Example 1 had a rosin acid content of 4.4 mass %.

The gas chromatographic measuring condition is as follows:
Column used: FFAP 0.32 mmφ×25 m (layer thickness: 0.3 μm)
Column temperature: 200° C-250° C.
Heating rate: 10° C./minute
Injector temperature: 270° C.
Detector temperature: 270° C.
Injection amount: 2 μl.

### <Preparation of Chloroprene Rubber Latex for Fiber Code Treatment>

Chloroprene: 100 parts by mass, 2,3-dichloro-1,3-butadiene: 3.0 parts by mass, sulfur: 0.5 parts by mass, pure water: 105 parts by mass, potassium salt of a disproportionated rosin acid (manufactured by Harima Chemicals, Inc.): 4.80 parts by mass, sodium hydroxide: 0.75 parts by mass, and sodium salt of a β-formalin naphthalenesulfonate condensate (trade name: DEMOL N: manufactured by Kao Corporation): 0.6 parts by mass were placed in a polymerization tank having a capacity of 30 liters.

Potassium persulfate: 0.1 parts by mass was added as polymerization initiator to the polymerization solution and the mixture was polymerized at a polymerization temperature of 40° C. under nitrogen stream. When the conversion rate reached 71%, a polymerization inhibitor diethyl hydroxyamine was added thereto to terminate polymerization and the latex obtained was distilled under reduced pressure to remove the unreacted monomer.

Subsequently, a plasticizer emulsion consisting of chloroprene: 3.0 parts by mass, tetraethylthiuram disulfide (trade name: Nocceler TET, manufactured by Ouchi Shinko Chemical Industrial): 2.7 parts by mass, sodium salt of a β-formalin naphthalenesulfonate condensate: 0.05 parts by mass, and sodium laurylsulfate: 0.05 parts by mass were added to the latex, and the mixture was kept under agitation at a temperature of 50° C. for 1 hour for plasticization, to give a latex for RFL treatment (e).

### <RFL Treatment>

First, 1 mol of resorcin and 2 mol of 37 mass % aqueous formaldehyde solution were mixed; 0.75 mol of 5 mass % aqueous NaOH solution was added thereto; the mixture was stirred and adjusted to a solid matter concentration of 6.9 mass % and left in the tightly sealed state at 25° C.±1° C. for 6 hours, to give a RF (resorcin and formaldehyde) solution. Then, the RF solution and the latex (e) (resorcin, formaldehyde, latex) described above were mixed and adjusted, to give a RFL solution. Untreated polyester fiber codes were immersed in the RFL solution for 15 seconds, dehydrated and dried in a constant-temperature dryer at 120° C. for 2 minutes, baked at 150° C. for 6 minutes, and additionally heat-set at 200° C. for 3 minutes.

### <Preparation of Test Sample>

Stearic acid: 1 part by mass, octylated diphenylamine: 2 parts by mass, magnesium oxide: 4 parts by mass, carbon black (GPF): 40 parts by mass, and zinc oxide: 5.0 parts by mass were added to the sulfur-modified chloroprene rubber of Example 1: 100 parts by mass; the mixture was mixed and sheeted with an 8-inch roll, to give a stripe-shaped rubber sheet (f) for test having a sheet length of 120 mm, a sheet width of 5.4 mm, and a thickness of 2.2 mm. The test sample was subjected to the following test:

### <Preparation of Test Sample for H Test>

A fabric and a test rubber sheet (f) previously cut to predetermined sizes were placed in a mold having a code groove of 0.8 mm, a depth of 3.0 mm, and a fiber code distance of 25.0 mm; the RFL-treated fiber code was placed in the groove; and additionally, the test rubber sheet (f) and the fabric were placed thereon in that order. After the upper mold was connected to the mold, the composite was left vulcanized under pressure at 160° C. for 20 minutes. The test sample after vulcanization was cooled and cut to give an H-shaped test sample. The test sample was left in a temperature-controlled room at 23° C. for 20 hours, to give a test sample for H test.

### <H Test>

The adhesive force of the test sample for H test prepared by the method described above was determined, using Autograph AGIS-5KN manufactured by Shimadzu Corp. The H test was performed in a temperature-controlled room at 23° C. under the condition of a tension speed of 5 mm/second. As a result, the maximum point test force of the test sample prepared from the sulfur-modified chloroprene rubber of Example 1 was 110N.

### Examples 2 to 15, Comparative Examples 1 to 8

The sulfur-modified chloroprene rubbers of Examples 2 to 15 and Comparative Examples 1 to 8 respectively having the compositions shown in Tables 1 to 3 below were prepared and evaluated by a method and a condition similar to those in Example 1. The results above are summarized in the following Tables 1 to 3.

TABLE 1

| | | | Example | | | | | | | |
|---|---|---|---|---|---|---|---|---|---|---|
| | | Unit | 1 | 2 | 3 | 4 | 5 | 6 | 7 | 8 |
| 2-Chloro-1,3-butadiene | | parts by mass | 100 | 100 | 100 | 100 | 100 | 100 | 100 | 100 |
| 2,3-Dichloro-1,3-butadiene | | parts by mass | 3 | 3 | 3 | 3 | 3 | 3 | 3 | 3 |
| Sulfur | | parts by mass | 0.5 | 0.5 | 0.5 | 0.5 | 0.5 | 0.5 | 0.5 | 0.5 |
| Pure water | | parts by mass | 120 | 120 | 120 | 120 | 120 | 120 | 120 | 120 |
| Potassium salt of disproportionated rosin acid | | parts by mass | 3.8 | 3.8 | 3.8 | 3.8 | 3.8 | 3.8 | 3.8 | 3.8 |
| Sodium hydroxide | | parts by mass | 0.59 | 0.59 | 0.59 | 0.59 | 0.59 | 0.59 | 0.59 | 0.59 |
| Sodium salt of β-formalin naphthalenesulfonate | | parts by mass | 0.5 | 0.5 | 0.5 | 0.5 | 0.5 | 0.5 | 0.5 | 0.5 |
| condensate | | | | | | | | | | |
| Conversion rate | | % | 75 | 77 | 73 | 76 | 71 | 80 | 75 | 72 |
| Aqueous | Concentration of tetramethylthiuram | mass % | 40 | 70 | 70 | 40 | 40 | 40 | 10 | 10 |
| medium | disulfide (mass %) | | | | | | | | | |
| dispersion | Concentration of tetraethylthiuram | mass % | — | — | — | 10 | 10 | — | — | 4 |
| | disulfide (mass %) | | | | | | | | | |
| | Aqueous medium dispersion | parts by mass | 4 | 4 | 2.3 | 4 | 3 | 4 | 4 | 10 |
| Plasticizer | 2-Chloro-1,3-butadiene | parts by mass | — | — | — | — | 3 | 3 | — | — |
| emulsion | Tetramethylthiuram disulfide | parts by mass | — | — | — | — | — | 0.3 | — | — |
| | Tetraethylthiuram disulfide | parts by mass | — | — | — | — | — | 1 | 2 | — |
| | Sodium salt of β-formalin | parts by mass | — | — | — | — | — | 0.05 | 0.05 | — |
| | naphthalenesulfonate condensate | | | | | | | | | |
| | Sodium laurylsulfate | parts by mass | — | — | — | — | — | 0.05 | 0.05 | — |
| 1H-NMR | Presence of peak at 3.55 to 3.61 ppm | — | yes | yes | yes | yes | yes | yes | yes | yes |
| | Presence of peak at 3.41 to 3.47 ppm | — | yes | yes | yes | yes | yes | yes | yes | yes |
| | Presence of peak at 4.2 to 6.5 ppm | — | yes | yes | yes | yes | yes | yes | yes | yes |
| | Area ratio (A/B) of peak area (A) at 3.55 to | — | 0.35/100 | 0.53/100 | 0.33/100 | 0.34/100 | 0.32/100 | 0.40/100 | 0.06/100 | 0.18/100 |
| | 3.61 ppm to peak area (B) at 4.2 to 6.5 ppm | | | | | | | | | |
| Mooney viscosity of crude rubber | | — | 42 | 34 | 44 | 37 | 40 | 35 | 47 | 44 |
| (ML1 + 4 at 100° C.) | | | | | | | | | | |
| Extract with ethanol/toluene azeotropic mixture | | mass % | 7.2 | 7.7 | 7.4 | 7.6 | 7.5 | 7.8 | 7.6 | 7.4 |
| Rosin acid content | | mass % | 4.4 | 4.1 | 4.4 | 4.3 | 4.3 | 4.6 | 4.4 | 4.5 |
| Evaluation | H test maximum point test force | N | 110 | 112 | 103 | 100 | 99 | 111 | 88 | 96 |

TABLE 2

| | | | Example | | | | | | | |
|---|---|---|---|---|---|---|---|---|---|---|
| | | Unit | 9 | 10 | 11 | 12 | 13 | 14 | 15 | 16 |
| 2-Chloro-1,3-butadiene | | parts by mass | 100 | 100 | 100 | 100 | 100 | 100 | 100 | 100 |
| 2,3-Dichloro-1,3-butadiene | | parts by mass | 3 | 3 | 0 | 20 | 25 | 3 | 3 | 3 |
| Sulfur | | parts by mass | 0.5 | 0.5 | 0.5 | 0.5 | 0.5 | 0.5 | 0.5 | 0.5 |
| Pure water | | parts by mass | 120 | 120 | 120 | 120 | 120 | 120 | 120 | 120 |
| Potassium salt of disproportionated rosin acid | | parts by mass | 5.2 | 3 | 3.8 | 3.8 | 3.8 | 5.7 | 5 | 2.6 |
| Sodium hydroxide | | parts by mass | 0.59 | 0.59 | 0.59 | 0.59 | 0.59 | 0.59 | 0.59 | 0.59 |
| Sodium salt of β-formalin naphthalenesulfonate | | parts by mass | 0.3 | 0.5 | 0.5 | 0.5 | 0.5 | 0.3 | 1 | 0.3 |
| condensate | | | | | | | | | | |
| Conversion rate | | % | 74 | 70 | 73 | 71 | 71 | 81 | 80 | 78 |
| Aqueous | Concentration of tetramethylthiuram | mass % | 40 | 40 | 40 | 40 | 40 | 40 | 40 | 30 |
| medium | disulfide (mass %) | | | | | | | | | |
| dispersion | Concentration of tetraethylthiuram | mass % | — | — | — | — | — | 10 | 20 | — |
| | disulfide (mass %) | | | | | | | | | |
| | Aqueous medium dispersion | parts by mass | 4 | 4 | 4 | 4 | 3 | 4 | 4 | 4 |
| Plasticizer | 2-Chloro-1,3-butadiene | parts by mass | — | — | — | — | — | — | — | — |
| emulsion | Tetramethylthiuram disulfide | parts by mass | — | — | — | — | — | — | — | — |
| | Tetraethylthiuram disulfide | parts by mass | — | — | — | — | — | — | — | — |
| | Sodium salt of β-formalin | parts by mass | — | — | — | — | — | — | — | — |
| | naphthalenesulfonate condensate | | | | | | | | | |
| | Sodium laurylsulfate | parts by mass | — | — | — | — | — | — | — | — |
| 1H-NMR | Presence of peak at 3.55 to 3.61 ppm | — | yes | yes | yes | yes | yes | yes | yes | yes |
| | Presence of peak at 3.41 to 3.47 ppm | — | yes | yes | yes | yes | yes | yes | yes | yes |
| | Presence of peak at 4.2 to 6.5 ppm | — | yes | yes | yes | yes | yes | yes | yes | yes |
| | Area ratio (A/B) of peak area (A) at 3.55 to | — | 0.35/100 | 0.35/100 | 0.34/100 | 0.31/100 | 0.32/100 | 0.36/100 | 0.34/100 | 0.25/100 |
| | 3.61 ppm to peak area (B) at 4.2 to 6.5 ppm | | | | | | | | | |
| Mooney viscosity of crude rubber | | — | 42 | 44 | 41 | 43 | 44 | 46 | 35 | 50 |
| (ML1 + 4 at 100° C.) | | | | | | | | | | |
| Extract with ethanol/toluene azeotropic mixture | | mass % | 8.8 | 4.3 | 7.3 | 7.3 | 7.3 | 8.9 | 9.3 | 3.2 |
| Rosin acid content | | mass % | 6.5 | 2.6 | 4.4 | 4.5 | 4.4 | 7.1 | 6.7 | 1.9 |
| Evaluation | H test maximum point test force | N | 104 | 100 | 112 | 89 | 78 | 81 | 80 | 87 |

TABLE 3

| | | | Comparative Example | | | | | | | |
|---|---|---|---|---|---|---|---|---|---|---|
| | | Unit | 1 | 2 | 3 | 4 | 5 | 6 | 7 | 8 |
| 2-Chloro-1,3-butadiene | | parts by | 100 | 100 | 100 | 100 | 100 | 100 | 100 | 100 |
| | | mass | | | | | | | | |
| 2,3-Dichloro-1,3-butadiene | | parts by | 3 | 3 | 3 | 3 | 3 | 3 | 3 | 3 |
| | | mass | | | | | | | | |
| Sulfur | | parts by | 0.50 | 0.50 | 0.50 | 0.05 | 2.20 | 0.50 | 0.50 | 0.50 |
| | | mass | | | | | | | | |
| Pure water | | parts by | 120 | 120 | 120 | 120 | 120 | 120 | 120 | 120 |
| | | mass | | | | | | | | |
| Potassium salt of | | parts by | 3.80 | 3.80 | 3.80 | 3.80 | 3.80 | 3.80 | 3.80 | 3.80 |
| disproportionated rosin acid | | mass | | | | | | | | |
| Sodium hydroxide | | parts by | 0.59 | 0.59 | 0.59 | 0.59 | 0.59 | 0.59 | 0.59 | 0.59 |
| | | mass | | | | | | | | |
| Sodium salt of β-formalin | | parts by | 0.5 | 0.5 | 0.5 | 0.5 | 0.5 | 0.5 | 0.5 | 0.5 |
| naphthalenesulfonate condensate | | mass | | | | | | | | |
| Conversion rate | | % | 75 | 78 | 76 | 73 | 75 | 55 | 95 | 76 |
| Aqueous | Concentration of | mass % | 8 | — | 65 | 40 | 40 | 40 | 40 | 75 |
| medium | tetramethylthiuram | | | | | | | | | |
| dispersion | disulfide (mass %) | | | | | | | | | |
| | Concentration of | mass % | 15 | — | — | — | — | — | — | — |
| | tetraethylthiuram | | | | | | | | | |
| | disulfide (mass %) | | | | | | | | | |
| | Aqueous medium dispersion | parts by | 2 | — | 6 | 4 | 4 | 4 | 4 | 4 |
| | | mass | | | | | | | | |
| Plasticizer | 2-Chloro-1,3-butadiene | parts by | 3.0 | 3.0 | — | — | — | — | — | — |
| emulsion | | mass | | | | | | | | |
| | Tetramethylthiuram disulfide | parts by | — | — | — | — | — | — | — | — |
| | | mass | | | | | | | | |
| | Tetraethylthiuram disulfide | parts by | 2.0 | 2.5 | — | — | — | — | — | — |
| | | mass | | | | | | | | |
| | Sodium salt of β-formalin | parts by | 0.05 | 0.05 | — | — | — | — | — | — |
| | naphthalenesulfonate | mass | | | | | | | | |
| | condensate | | | | | | | | | |
| | Sodium laurylsulfate | parts by | 0.05 | 0.05 | — | — | — | — | — | — |
| | | mass | | | | | | | | |
| 1H-NMR | Presence of peak at | — | yes | yes | yes | yes | yes | yes | yes | The |
| | 3.55 to 3.61 ppm | | | | | | | | | aqueous |
| | Presence of peak at | — | yes | yes | yes | yes | yes | yes | yes | medium |
| | 3.41 to 3.47 ppm | | | | | | | | | dispersion |
| | Presence of peak at | — | yes | yes | yes | yes | yes | yes | yes | was |
| | 4.2 to 6.5 ppm | | | | | | | | | too |
| | Area ratio (A/B) of peak area | — | 0.02/100 | 0.00/100 | 0.71/100 | 0.15/100 | 0.40/100 | 0.33/100 | 0.40/100 | viscous |
| | (A) at 3.55 to 3.61 ppm to peak | | | | | | | | | and |
| | area (B) at 4.2 to 6.5 ppm | | | | | | | | | not |
| Mooney viscosity of crude rubber | | — | 39 | 40 | 12 | No | 10 | 11 | 90 | added. |
| (ML1 + 4 at 100° C.) | | | | | | measurement | | | | |
| | | | | | | possible | | | | |
| Extract with ethanol/toluene | | mass % | 7.2 | 7.4 | 7.7 | 6.9 | 7.0 | 7.4 | 6.9 | |
| azeotropic mixture | | | | | | | | | | |
| Rosin acid content | | mass % | 4.4 | 4.6 | 4.5 | 4.4 | 4.3 | 4.5 | 4.1 | |
| Evaluation | H test maximum | N | 76 | 70 | No | No | No | No | No | |
| | point test force (N) | | | | measure- | measure- | measure- | measure- | measure- | |
| | | | | | ment | ment | ment | ment | ment | |
| | | | | | possible | possible | possible | possible | possible | |

As shown in Table 3 above, the sulfur-modified chloroprene rubber of Comparative Example 1, which was prepared using an aqueous medium dispersion containing a smaller amount of tetramethylthiuram disulfide, had a peak area ratio (A/B) of less than 0.05/100 in ¹H-NMR, indicating that the terminal modification with tetramethylthiuram disulfide was insufficient. Thus, it was less adhesive. Alternatively the sulfur-modified chloroprene rubber of Comparative Example 2, which was prepared not using the aqueous medium dispersion containing tetramethylthiuram disulfide in an amount of 10 to 70 mass % in the plasticizing step, did not have peak tops at 3.55 to 3.61 ppm and 3.41 to 3.47 ppm. In other words, the sulfur-modified chloroprene rubber of Comparative Example 2 did not have tetramethylthiuram disulfide-derived dimethylthiuram sulfide bonded to the terminal of the chloroprene chain and was thus less adhesive.

On the other hand, the sulfur-modified chloroprene rubber of Comparative Example 3, which had a peak area ratio (A/B) of more than 0.70/100 in ¹H-NMR, was too tacky and did not give a test sample. It is probably because the terminal modification with tetramethylthiuram disulfide progressed excessively, as an aqueous medium dispersion having a higher tetramethylthiuram disulfide concentration (65 mass %) is used in an excessive amount of 6 parts by mass with respect to 100 parts by mass of the monomer in Comparative Example 3.

The sulfur-modified chloroprene rubber of Comparative Example 4, which was prepared at a sulfur addition amount of less than 0.1 parts by mass, did not give a sample because of scorching. In addition, the sulfur-modified chloroprene rubber of Comparative Example 4 was a gel polymer and thus, the viscosity thereof could not be determined. On the other hand, the sulfur-modified chloroprene rubber of Comparative Example 5, which was prepared at a sulfur addition amount of more than 2.0 parts by mass, had a low Mooney viscosity of the crude rubber and was too tacky, prohibiting preparation of the test sample.

The sulfur-modified chloroprene rubber of Comparative Example 6, which was prepared at a monomer conversion rate of less than 60%, had a low Mooney viscosity of crude rubber and was too tacky, prohibiting preparation of the test sample. On the other hand, the sulfur-modified chloroprene rubber of Comparative Example 7, which was prepared at a monomer conversion rate of more than 90%, had an excessively high Mooney viscosity of crude rubber and did not give a sample because of scorching during kneading operation.

The sulfur-modified chloroprene rubber of Comparative Example 8, which was prepared with an aqueous medium dispersion containing tetramethylthiuram disulfide in an amount of more than 70 mass %, gave a highly viscous aqueous medium dispersion, which could not be added to the reaction solution.

In contrast, the sulfur-modified chloroprene rubbers of Examples 1 to 15 shown in Tables 1 and 2 were superior in adhesiveness. The results above show that it is possible according to the present invention to obtain a sulfur-modified chloroprene rubber superior in the adhesiveness to the cable core and the fibrous reinforcement material.

Although not shown in the Tables, the sulfur-modified chloroprene rubbers of the Examples gave respectively transmission belts superior in adhesiveness of the rubber material to the cable core and the fibrous reinforcement material.

Although not shown in the Tables, the sulfur-modified chloroprene rubbers of the Examples gave respectively conveyor belts superior in adhesiveness of the rubber material to the cable core and the fibrous reinforcement material.

Although a few embodiments of the present invention have been shown and described, it would be appreciated by those skilled in the art that changes may be made in this embodiment without departing from the principles and spirit of the invention, the scope of which is defined in the claims and their equivalents.

1. A sulfur-modified chloroprene rubber, prepared by mixing 100 parts by mass of 2-chloro-1,3-butadiene and 0.1 to 2.0 parts by mass of sulfur, emulsion-polymerizing the mixture to a monomer conversion rate of 60 to 90%, and modifying the polymer terminal thereof by adding an aqueous medium dispersion containing tetramethylthiuram disulfide in an amount of 10 to 70 mass %, wherein:
the ¹H-NMR spectrum, as determined in deuterochloroform solvent, has peak tops at 3.55 to 3.61 ppm and at 3.41 to 3.47 ppm, and
the ratio (NB) of peak area (A) at 3.55 to 3.61 ppm to peak area (B) at 4.2 to 6.5 ppm is 0.05/100 to 0.70/100.

2. The sulfur-modified chloroprene rubber according to claim 1, prepared by additionally mixing other monomers in an amount in the range of less than 50 parts by mass with respect to 100 parts by mass of 2-chloro-1,3-butadiene and copolymerizing the mixture.

3. The sulfur-modified chloroprene rubber according to claim 2, prepared by additionally mixing other monomers in an amount in the range of 20 parts or less by mass with respect to 100 parts by mass of 2-chloro-1,3-butadiene and copolymerizing the mixture.

4. The sulfur-modified chloroprene rubber according to claim 1, wherein the extract thereof with the ethanol/toluene azeotropic mixture, as determined by the method specified in JIS K 6229, is 3.0 to 9.0 mass %.

5. The sulfur-modified chloroprene rubber according to claim 1, wherein the rosin acid content thereof, as determined by gas chromatograph, is 2.0 to 7.0 mass%.

6. A method for producing a sulfur-modified chloroprene rubber, comprising:
a polymerization step of mixing 100 parts by mass of 2-chloro-1,3-butadiene and 0.1 to 2.0 parts by mass of sulfur and emulsion-polymerizing the mixture to a monomer conversion rate in the range of 60 to 90%; and
a plasticizing step of modifying the terminal of the polymer by adding an aqueous medium dispersion containing tetramethylthiuram disulfide in an amount of 10 to 70 mass % to the reaction solution after polymerization, wherein:
the ¹H-NMR spectrum of the sulfur-modified chloroprene rubber, as determined in deuterochloroform solvent, has two peak tops at 3.55 to 3.61 ppm and at 3.41 to 3.47 ppm, and the ratio (A/B) of peak area (A) at 3.55 to 3.61 ppm to peak area (B) at 4.2 to 6.5 ppm is 0.05/100 to 0.70/100.

7. The method for producing a sulfur-modified chloroprene rubber according to claim 6, wherein the unreacted monomer is removed before the plasticizing step or after the plasticizing step.

8. The method for producing a sulfur-modified chloroprene rubber according to claim 6, wherein other monomers in an amount in the range of less than 50 parts by mass with respect to 100 parts by mass of 2-chloro-1,3-butadiene is added and copolymerized in the polymerization step.

9. A molded body, prepared from the sulfur-modified chloroprene rubber according to claim 1.

10. The molded body according to claim 9, which is a transmission belt or a conveyor belt.

11. The method for producing a sulfur-modified chloroprene rubber according to claim 7, wherein other monomers in an amount in the range of less than 50 parts by mass with respect to 100 parts by mass of 2-chloro-1,3-butadiene is added and copolymerized in the polymerization step.
